(19) United States
(12) Patent Application Publication
(10) Pub. No.: US 2012/0048719 A1
(43) Pub. Date: Mar. 1, 2012

(54) SILANE DISTILLATION WITH REDUCED ENERGY USE

(75) Inventors: Peter Nuernberg, Nuenchritz (DE); Birgit Froebel, Nuenchritz (DE); Michael Hallmann, Duttendorf (AT); Christian Kaltenmarkner, Burghausen (DE); Benedikt Postberg, Neuoetting (DE)

(73) Assignee: WACKER CHEMIE AG, Muenchen (DE)

(21) Appl. No.: 13/318,932

(22) PCT Filed: May 5, 2010
(86) PCT No.: PCT/EP10/56090

§ 371 Date: Nov. 4, 2011

(30) Foreign Application Priority Data
May 15, 2009 (DE) 10 2009 003 163.4

(51) Int. Cl. B01D 3/00

(52) U.S. Cl. 203/26

(57) ABSTRACT

The invention relates to a method for thermally separating silane mixtures, which contain silanes, selected from alkylchlorosilanes and hydrochlorosilanes, in a distillation apparatus, in which at least part of the heat for heating the distillation apparatus is transferred by vapors of another distillation apparatus, and in which a silane product is obtained having impurities of no more than 200 ppm.

The invention relates to a process for distilling silane mixtures, in which heat for heating the distillation apparatus is transferred from vapor from a further distillation apparatus and a pure silane product is obtained.

In the field of chlorosilane and methylchlorosilane distillation, classical distillation concepts have hitherto been used because of the high purity requirements and the product properties of the participating materials, in particular their corrosive behavior in the presence of moisture, sometimes high combustibility of the liquids, reactivity toward protic solvents and metal oxides. Here, the energy introduced in the form of heating steam or other heat transfer media is released into the surroundings via air or water condensers. The boiling points of the pure materials are close together.

Energy recovery concepts have not been employed because of these difficulties and the mutual influencing of the columns and separation steps.

DE 10 2008 000 490 A describes a distillation process for silanes, in which the enrichment section of the column is operated at a higher pressure than the stripping section and heat from the enrichment section is passed to the stripping section and the low-boiling fraction is separated off in the enrichment section and the high-boiling fraction is separated off in the stripping section. Distillate is used here as heat-transferring operating medium, but this process is problematical in terms of its part-load behavior. A high-purity silane product is not obtained.

Processes for energy recovery are described, for example, in “Verfahrenstechnische Berechnungsmethoden Teil 2—Thermisches Trennen; VEB Deutscher Verlag fur Grundstoffindustrie, Leipzig, 1986, pp. 185-190, in particular p. 185. It is mentioned there that the overhead product vapor from one column can be utilized as heating medium at the bottom of another column.

The difficulty in silane distillation is, in particular, in its high purity requirements; for example, dimethyldichlorosilane having very low contents of methyltrichlorosilane and ethyldichlorosilane is demanded, although the contents of the latter components in the silane mixture to be distilled fluctuate widely.

These boundary conditions require extremely stable setting of the operating parameters of the integrated distillation system and also variable adaptation of the operating parameters to the changing silane mixture compositions.

In industrial operation, recourse is therefore made to “normal loads” by means of conventional vaporizers and condensers for heat recovery in pure distillation. These stabilize the distillation process in order to be able to carry out pure distillations with high purity requirements and fluctuating feed compositions in an energetically effective manner.

The invention provides a process for the thermal separation of silane mixtures containing silanes selected from among alkylchlorosilanes and hydrogenchlorosilanes in a distillation apparatus, wherein at least part of the heat for heating the distillation apparatus is transferred from vapor from a further distillation apparatus and a silane product having impurity contents of not more than 200 ppm is obtained.

In the process, the energy content of the vapor stream which was hitherto released into the surroundings via heat transfer media is used. The process allows up to 85% of the energy to be saved compared to conventional distillation. This energy saving surprisingly succeeds despite the distillation of high-purity alkylchlorosilanes and hydrogenchlorosilanes.

Preference is given to condensing the vapor and using the heat of condensation for heating the distillation apparatus.

The distillation apparatus preferably consists of one or more columns. The further distillation apparatus preferably consists of one or more columns.

Preference is given to at least 20% by weight, in particular at least 50% by weight, of the vapor from the further distillation apparatus supplying heat for heating the distillation apparatus.

Preference is given to at least 10%, in particular at least 20%, of the heat for heating the distillation apparatus being transferred from vapor from a further distillation apparatus.

Preference is given to heat being transferred from the vapor from the further distillation apparatus to a heat transfer medium at a heat exchanger and this heat transfer medium being used for heating the distillation apparatus. In particular, heat is transferred from the vapor of the further distillation apparatus to a heat exchanger by condensation. The heat of the vapor from the further distillation apparatus is preferably used as heat source in a cyclic process. The heat of the vapor from the further distillation apparatus is preferably passed on by means of a heat pump. Preference is given to using the vapor from the further distillation apparatus for heating the bottom of the distillation apparatus.

The distillation apparatus is preferably a column.

In a preferred embodiment, the vapor obtained at the top of a column is compressed and thereby heated. In a heat exchanger, heat is then transferred to a heat transfer medium and this heat transfer medium is used for heating the bottom of this column. The distillation apparatus and the further distillation apparatus are in this case identical.

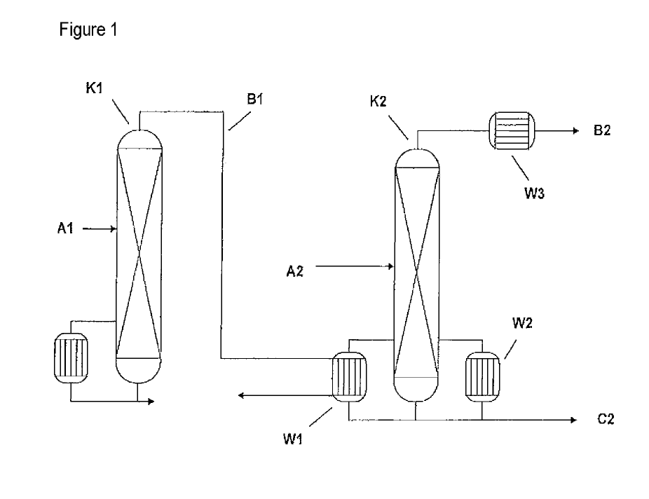

A further preferred embodiment is illustrated by FIG. 1: in a column (K1), a silane mixture (A1) is distilled. The vapor (B1) taken off at the top is condensed in a heat exchanger (W1) and transfers heat to a heat transfer medium. The heat transfer medium heats the bottom of the column (K2). The heat transfer medium can be additionally heated in a further heat exchanger (W2). Silane mixture (A2) is fed to the column (K2) and distilled. The vapor (B2) taken off at the top of the column (K2) is condensed in a heat exchanger (W3) and transfers heat to a heat exchanger. The bottoms (C2) are discharged at the bottom of the column (K2).

The silane product produced is preferably obtained with impurity contents of not more than 200 ppm at the bottom of the distillation apparatus. Preference is given to silane mixtures containing silanes selected from among alkylchlorosilanes and hydrogenchlorosilanes also being separated in the further distillation apparatus. Preference is given to silane product having impurity contents of not more than 200 ppm also being produced in the further distillation apparatus.

The alkylchlorosilanes and/or hydrogenchlorosilanes to be separated preferably correspond to the general formula (1)

R¹ₐH_{b}SiCl₄-a-b (1),

where
R¹ is a hydrocarbon radical having 1-10 carbon atoms,
a is 0, 1, 2, 3 or 4 and
b is 0, 1, 2 or 3.

Particularly preferred hydrocarbon radicals R¹ are alkyl radicals having from 1 to 6 carbon atoms, in particular the methyl and ethyl radicals.

The silane product produced preferably contains not more than 100 ppm, particularly preferably not more than 50 ppm, in particular not more than 20 ppm, of impurities.

The proportion of an individual compound among the impurities is preferably not more than 100 ppm, particularly preferably not more than 60 ppm, in particular not more than 15 ppm.

In a preferred embodiment, dimethyldichlorosilane which preferably contains in each case not more than 100 ppm, particularly preferably not more than 60 ppm, in particular not more than 15 ppm, of methyltrichlorosilane and ethyldichlorosilane is obtained.

Preference is given to using mixtures which in addition to dimethyldichlorosilane contain silanes selected from among methyltrichlorosilane, trimethylchlorosilane and methylhydrogendichlorosilane.

The above ppm values are by weight.

In the following examples, all amounts and percentages are by weight, all pressures are 0.10 MPa (abs.) and all temperatures are 20° C., unless indicated otherwise. The reference symbols refer to FIG. 1.

In the examples, a silane mixture (A) composed of 90% of dimethyldichlorosilane, 7% of methyltrichlorosilane, 2% of trimethylchlorosilane and 1% of methylhydrogendichlorosilane is separated at a flow rate of 7 t/h into two fractions in a column (K2). The overhead product (B) consists of 18% of dimethyldichlorosilane, 58% of methyltrichlorosilane, 16% of trimethylchlorosilane and 8% of methylhydrogendichlorosilane. The bottom product (C) consists of 100% of dimethyldichlorosilane. The dimethyldichlorosilane can be distilled as required with a methyltrichlorosilane impurity content of less than 80 ppm, of less than 20 ppm and in particular of 10-15 ppm.

### EXAMPLE 1, NOT ACCORDING TO THE Invention

In the conventional distillation, 2.3 MW of heat energy is supplied in the column (K2) at the heat exchanger (W2).

### EXAMPLE 2

In an integrated heat system with a column (K1), 1.9 MW of the required heat for heating the column (K2) is provided by vapor condensation at the heat exchanger (W1). At the heat exchanger (W2), a further 0.4 MW of heat is transferred. The energy saving is 83%.

### EXAMPLE 3

In the vapor compression in the column (K2), the vapor (B2) having a heat power of 1.9 MW is compressed with a further energy usage of 0.3 MW (compression apparatus and line to heat exchanger (W2) not shown in FIG. 1) and heats the bottom of the column (K2) via the heat exchanger (W2). The energy saving is 87%.

### EXAMPLE 4

Vapor from other columns (K3) and (K4) supplies 1.5 MW of heat of condensation to a heat pump (columns (K3) and (K4) and the heat pump not shown in FIG. 1). This heats, with introduction of a further 0.8 MW, the bottom of the column (K2) via heat exchanger (W1). The energy saving is 65%.

1. A process for a thermal separation in a distillation apparatus of silane mixtures containing silanes selected from the group consisting of alkylchlorosilanes and hydrogenchlorosilanes, wherein at least part of a heat for heating the distillation apparatus is transferred from vapor from a further distillation apparatus and a silane product having impurity contents of not more than 200 ppm is obtained.

2. The process as claimed in claim 1, wherein the vapor from the further distillation apparatus is condensed.

3. The process as claimed in claim 1, wherein heat is transferred from the vapor from the further distillation apparatus to a heat transfer medium at a heat exchanger and the heat transfer medium is used for heating the distillation apparatus.

4. The process as claimed in claim 1, wherein the distillation apparatus is a column.

5. The process as claimed in claim 4, wherein the vapor obtained at a top of a column is compressed and thereby heated and then transfers heat to a heat transfer medium in a heat exchanger and the heat transfer medium is used for heating a bottom of the column.

6. The process as claimed in claim 1, wherein the silane product produced is obtained with impurity contents of not more than 200 ppm at a bottom of the distillation apparatus.

7. The process as claimed in claim 1, wherein dimethyldichlorosilane containing in each case not more than 60 ppm of methyltrichlorosilane and ethyldichlorosilane is obtained as the silane product.

8. The process as claimed in claim 2, wherein heat is transferred from the vapor from the further distillation apparatus to a heat transfer medium at a heat exchanger and the heat transfer medium is used for heating the distillation apparatus.

9. The process as claimed in claim 3, wherein the distillation apparatus is a column.

10. The process as claimed in claim 8, wherein the distillation apparatus is a column.

11. The process as claimed in claim 10, wherein the vapor obtained at a top of the column is compressed and thereby heated and then transfers heat to a heat transfer medium in a heat exchanger and the heat transfer medium is used for heating a bottom of the column.

12. The process as claimed in claim 5, wherein the silane product produced is obtained with impurity contents of not more than 200 ppm at a bottom of the distillation apparatus.

13. The process as claimed in claim 11, wherein the silane product produced is obtained with impurity contents of not more than 200 ppm at a bottom of the distillation apparatus.

14. The process as claimed in claim 6, wherein dimethyldichlorosilane containing in each case not more than 60 ppm of methyltrichlorosilane and ethyldichlorosilane is obtained as the silane product.

15. The process as claimed in claim 13, wherein dimethyldichlorosilane containing in each case not more than 60 ppm of methyltrichlorosilane and ethyldichlorosilane is obtained as the silane product.
